(19) United States
(12) Patent Application Publication
(10) Pub. No.: US 2014/0377593 A1
(43) Pub. Date: Dec. 25, 2014

(54) BATTERY PACK

(71) Applicant: SAMSUNG SDI CO., LTD., Yongin-si (KR)

(72) Inventor: Sung-Ho HONG, Yongin-si (KR)

(73) Assignee: SAMSUNG SDI CO., LTD., Yongin-si (KR)

(21) Appl. No.: 14/293,409

(22) Filed: Jun. 2, 2014

Related U.S. Application Data
(60) Provisional application No. 61/839,057, filed on Jun. 25, 2013.

(51) Int. Cl. H01M 2/34

(52) U.S. Cl. CPC H01M 2/34
USPC 429/7

(57) ABSTRACT

A battery pack includes a secondary battery, including an electrode tab extending from the secondary battery, the electrode tab including a first alignment portion and a protective circuit module including a tab mounting portion, the tab mounting portion including a second alignment portion that engages the first alignment portion.

### CROSS-REFERENCE TO RELATED APPLICATION

The present application claims priority under 35 U.S.C. §119 to U.S. Provisional Application No. 61/839,057, filed on Jun. 25, 2013, and entitled: “Battery Pack,” which is incorporated herein by reference in its entirety.

### BACKGROUND

1. Field

Embodiments relate to a battery pack.

2. Description of the Related Art

Recently, battery packs have been variously used as power sources of portable electronic devices. As the use of portable electronic devices has increased in various fields, the demand for battery packs has rapidly increased. The battery packs can be charged/discharged a plurality of times, and accordingly are economically and environmentally efficient. Thus, the use of the battery packs has been encouraged.

### SUMMARY

Embodiments are directed to a battery pack including a secondary battery, including an electrode tab extending from the secondary battery, the electrode tab including a first alignment portion, and a protective circuit module including a tab mounting portion, the tab mounting portion including a second alignment portion that engages the first alignment portion.

The second alignment portion may engage the first alignment portion when the electrode tab is aligned in an overlapping relationship with the tab mounting portion.

The electrode tab may extend from the secondary battery in a first direction. The tab mounting portion may extend on a surface of the protective circuit module in the first direction.

A width of the tab mounting portion may be about 1 to about 1.2 times the width of the electrode tab.

A width of the tab mounting portion may be about 5 to 7 mm, and a width of the electrode tab may be about 5 to 6 mm.

One of the first alignment portion and the second alignment portion may include a hole. The other one of the first alignment portion and the second alignment portion may include a projection associated therewith. The alignment portion may engage the hole.

The projection may have an integral, one piece construction with the alignment portion with which it is associated.

The first alignment portion may include a hole. The second alignment portion may include a projection that engages the hole.

The projection may have an integral, one piece construction with the tab mounting portion.

The projection may have a cross-section corresponding to a cross-section of the hole.

The projection may have a height greater than a height of the electrode tab such that an end portion of the projection protrudes from the hole.

The end portion of the projection may protrude from the hole by about 0.5 to about 1 mm.

The end portion of the projection may include a hook portion that engages the electrode tab on an opposite side of the electrode tab from the tab mounting portion.

The end portion of the projection may include a convex head portion that engages the electrode tab on an opposite side of the electrode tab from the tab mounting portion.

The battery pack may further include a coupling layer between the electrode tab and the tab mounting portion.

The coupling layer may have adhesive properties.

The coupling layer may be an Ag paste or a conductive adhesive.

The coupling layer may have an area that is equal to or less than an area of the tab mounting portion.

The electrode tab may include first and second electrode tabs extending from the secondary battery, each of the first and second electrode tabs including the first alignment portion. The tab mounting portion may include first and second tab mounting portions, each of the first and second tab mounting portions including the second alignment portion that engages the first alignment portion of a corresponding one of the first and second electrode tabs.

The battery may be a pouch-type battery.

### BRIEF DESCRIPTION OF THE DRAWINGS

Features will become apparent to those of skill in the art by describing in detail exemplary embodiments with reference to the attached drawings in which:

FIG. 1 illustrates a perspective view of a battery pack according to an embodiment.

FIG. 2 illustrates an exploded perspective view of the battery pack shown in FIG. 1.

FIG. 3A illustrates a sectional view taken along line I-I of FIG. 1.

FIG. 3B illustrates an exploded view of FIG. 3A.

FIG. 4 illustrates a sectional view of an electrode tab and a tab mounting portion according to another embodiment.

FIG. 5 illustrates a sectional view of an electrode tab and a tab mounting portion according to another embodiment.

FIG. 6 illustrates a sectional view of an electrode tab and a tab mounting portion according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when an element is referred to as being “connected to” another element, it can be directly connected to the other element or be indirectly connected to the other element with one or more intervening elements interposed therebetween. Like reference numerals refer to like elements throughout.

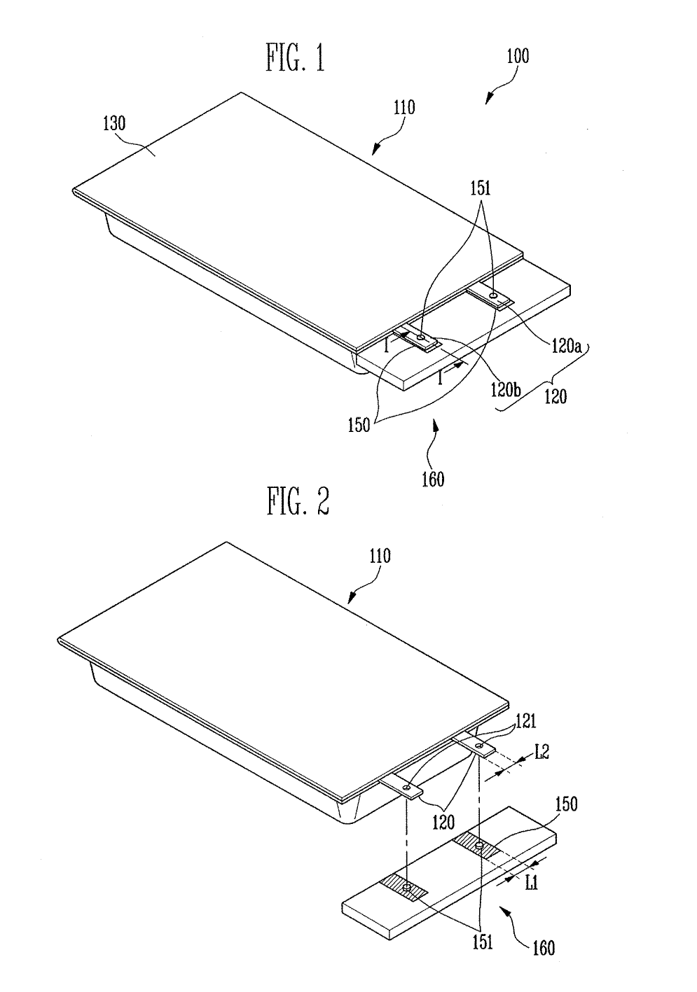

FIG. 1 illustrates a perspective view of a battery pack according to an embodiment. FIG. 2 illustrates an exploded perspective view of the battery pack shown in FIG. 1.

Referring to FIGS. 1 and 2, the battery pack 100 according to this embodiment may include a secondary battery 110 and a protective circuit module 160. The secondary battery 110 may include an electrode assembly including first and second electrode tabs 120a and 120b, and a battery case 130 that accommodates the electrode assembly therein such that the first and second electrode tabs 120a and 120b protrude to the outside of the battery case 130. The protective circuit module 160 may include a plurality of tab mounting portions 150 coupleable to the respective first and second electrode tabs 120a and 120b. Each of the first and second electrode tabs 120a and 120b may include a first alignment portion 121, and each tab mounting portion 150 may include a second alignment portion 151 that contacts the first alignment portion 121.

The battery pack 100 may include the secondary battery 110 and the protective module 160 electrically connected to the secondary battery 110. The first and second electrode tabs 120a and 120b may protrude from the battery case 130 of the secondary battery 110. The first and second electrode tabs 120a and 120b may be electrically connected to the respective tab mounting portions 150 of the protective circuit module 160.

The secondary battery 110 may include the battery case 130, and the electrode assembly and an electrolyte, which are accommodated in the battery case 130. The electrode assembly may include first and second electrode plates having different polarities, and a separator. For example, the first electrode plate may be a positive electrode plate formed by coating a positive electrode active material including lithium on a base material, and the second electrode plate may be a negative electrode plate formed by coating a negative electrode active material including carbon on a base material. The separator may be interposed between the first and second electrode plates so as to prevent the first and second electrode plates from coming in direct contact with each other. The separator may include a plurality of pores that form a passage for ions or the electrolyte.

The electrolyte may be accommodated together with the electrode assembly in the battery case 130. The electrolyte may allow current to easily flow between the first and second electrode plates. For example, the electrolyte may include a lithium salt serving as a supply source of lithium ions, and a non-aqueous organic solvent serving as a medium through which ions associated with an electrochemical reaction can move.

After the electrode assembly and the electrolyte are accommodated in the battery case 130, the battery case 130 may be sealed along an edge portion thereof. The edge portion of the battery case 130 may be sealed after the first and second electrode tabs 120a and 120b are provided to protrude to the outside of the battery case 130 through the edge portion of the battery case 130. The battery case 130 may be a pouch-type battery case in which polymer resin, thin-film metal and polymer resin are laminated in a plurality of layers. For example, the secondary battery 110 according to this embodiment may be a pouch-type secondary battery.

The battery pack 100 may include the protective circuit module 160 adjacent to the first and second electrode tabs 120a and 120b. The protective circuit module 160 may be electrically connected to the first and second electrode tabs 120a and 120b so as to control electrical flow in the battery pack 100. The protective circuit module 160 may include a secondary element, a circuit, or the like, which constitute a safety device of the battery pack 100. The plurality of tab mounting portions 150 connected to the respective first and second electrode tabs 120a and 120b may be in the protective circuit module 160.

The tab mounting portion 150 may have a size corresponding to that of each of the first and second electrode tabs 120a and 120b. The tab mounting portion 150 may be inside the protective circuit module 160, or may protrude to the outside of the protective circuit module 160 so as to face the respective first and second electrode tabs 120a and 120b. In this embodiment, the configuration in which the tab mounting portions 150 are mounted inside the protective circuit module 160 will be described.

The first and second electrode tabs 120 may be positioned on the respective tab mounting portions 150. The width L1 of the tab mounting portion 150 may be identical to or greater than the width L2 of each of the first and second electrode tabs 120. For example, the width L1 of the tab mounting portion 150 may be about 5 to 7 mm, and the width L2 of each of the first and second electrode tabs 120 may be about 5 to 6 mm. The width L1 of the tab mounting portion 150 may be 1.2 times or less of the width L2 of each of the first and second electrode tabs 120.

For example, each of the first and second electrode tabs 120 may include the first alignment portion 121, and the tab mounting portion 150 may include the second alignment portion 151 that contacts the first alignment portion 121. The first and second electrode tabs 120 may be mounted on the respective tab mounting portion 150 and then fixed through a process such as welding. In this case, the positions of the first and second electrode tabs 120 may be easily aligned by the first and second alignment portions 121 and 151. Thus, it may be possible to decrease the size of the tab mounting portion 150 corresponding to each of the first and second electrode tabs 120. After each of the first and second electrode tabs 120 is mounted on the tab mounting portion 150, each of the first and second electrode tabs 120 may be fixed to the tab mounting portion 150 by coupling the first and second alignment portions 121 and 151 to each other. It may be possible to easily perform the welding process and to decrease the margin of the tab mounting portion 150. Further, the space occupied by the tab mounting portion 150 may be decreased in the protective circuit module 160. It may be possible to efficiently use a space for a protective element, etc., mounted on the protective circuit module 160.

Generally, in a battery pack having first and second electrode tabs that protrude the outside of a battery case, a protective circuit module is provided corresponding to the width of a secondary battery. The width of the protective circuit module may be provided corresponding to that of a surface from which the first and second electrode tabs protrude in the secondary battery. In this case, each of the first and second electrode tabs is electrically connected to a tab mounting portion of the protective circuit module through welding. As the width of the secondary battery is variously changed, it may not be easy to align the position between the tab mounting portion of the protective circuit module and each of the first and second electrode tabs. The tab mounting portion may be frequently misaligned with each of the first and second electrode tabs, and a failure may occur in the welding process. As a result, the process efficiency may be decreased. If the size of the tab mounting portion, e.g., the width of the tab mounting portion is increased to be 1.6 times or more than the width of each of the first and second electrode tabs, production cost may be increased, and it may be difficult to secure welding quality. Further, a high-specification facility and a jig may be required to weld each of the first and second electrode tabs to the tab mounting portion.

In the battery pack according to the present embodiment, the position between the tab mounting portion and each of the first and second electrode tabs may be easily aligned, thereby improving the process efficiency. Further, the size of the tab mounting portion may be provided corresponding to that of each of the first and second electrode tabs. Furthermore, in the battery pack according to this embodiment, the position between the tab mounting portion and each of the first and second electrode tabs may be easily aligned without using a separate jig, so that it may be possible to prevent occurrence of a failure and to secure high welding quality.

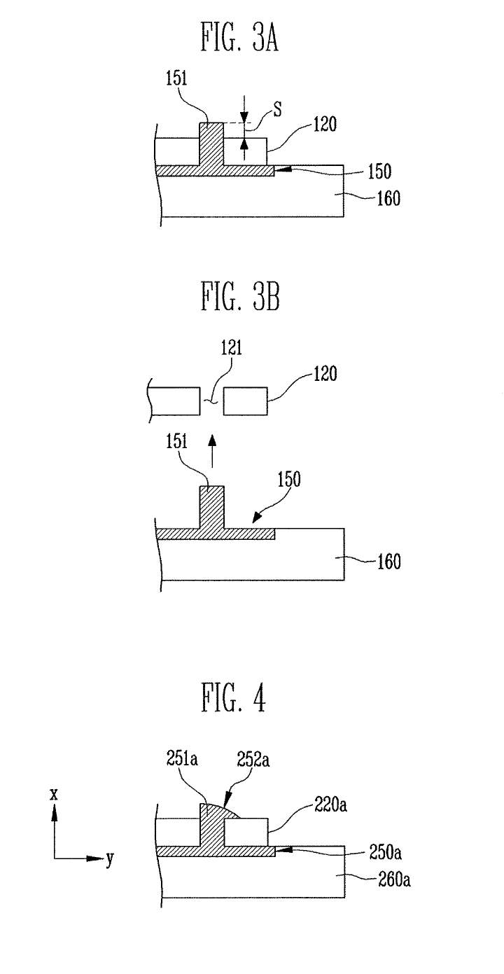

FIG. 3A illustrates a sectional view taken along line I-I of FIG. 1. FIG. 3B is an exploded view of FIG. 3A.

Referring to FIGS. 3A and 3B, the first alignment portion 121 provided to each of the first and second electrode tabs 120 and the second alignment portion 151 provided to the tab mounting portion 150 may be coupled to each other. For example, any one of the first and second alignment portions 121 and 151 may include an opening, and the other of the first and second alignment portions 121 and 151 may include a projection inserted into the opening. Although it has been described in this embodiment that the first alignment portion 121 is formed as an opening and the second alignment portion 151 is formed as a projection having a section corresponding to the opening, in other implementations, the first alignment portion 121 may be formed as a projection and the second alignment portion 151 may be formed as an opening.

When each of the first and second electrode tabs 120 is positioned on the tab mounting portion 150, the position of each of the first and second electrode tab 10 can be easily aligned with the tab mounting portion 150 by the first and second alignment portions 121 and 151. The projection as the second alignment portion 151 may be inserted into the opening as the first alignment portion 121. Accordingly, each of the first and second electrode tabs 120 may be fixed to the tab mounting portion 150, and a subsequent welding process may be easily performed.

After each of the first and second electrode tabs 120 is mounted on the tab mounting portion 150, the projection as the second alignment portion 151 may protrude to the outside of the opening by being inserted into the opening as the first alignment portion 121. A length S that the second alignment portion 151 protrudes from an outer surface of the first alignment portion 121 may be about 0.5 to 1 mm. A welding process between the tab mounting portion 150 and each of the first and second electrode tab 120 may be performed after the first length S of the second alignment portion 151 is pressed. If the first length S were to be less than 0.5 mm, each of the first and second electrode tab 120 may not be fixed to the tab mounting portion 150 and could be easily separated from the tab mounting portion 150 after the second alignment portion 151 is inserted into the first alignment portion 121. In such a case, it may be difficult to secure welding quality. For example, each of the first and second electrode tabs 120 and the tab mounting portion 150 may be made of metal that is an electrical conductor, and the frictional force between the tab mounting portion 150 and each of the first and second electrode tabs 120 may be low due to properties of the metal. According to embodiments, on the other hand, the first length S may be preferably provided as a suitable predetermined length in order to maintain the coupling between the first and second alignment portions 121 and 151 even after the second alignment portion 151 is inserted into the first alignment portion 121. For example, the first length S may be 0.5 mm or more. In addition, the first length S may be less than 1 mm. At least one portion of the first length S may be pressed in order to secure the welding quality before the welding process is performed. However, in a case where the first length S is longer than a predetermined length, for example longer than 1 mm, a portion to be pressed in the first length S is increased. Therefore, unnecessary energy may be wasted, thereby lowering the process efficiency. That is, the first length S may be, for example, 0.5 to 1 mm, in consideration of both the fixing force between the tab mounting portion 150 and each of the first and second electrode tabs 120 and the efficiency of the subsequent welding process. As an example, the first length S may be 0.8 mm.

Hereinafter, other embodiments will be described with reference to FIGS. 4 to 6. Contents of these embodiments, except the following contents, are similar to those of the embodiment described with reference to FIGS. 1 to 3, and therefore, their detailed descriptions will not be repeated.

FIG. 4 illustrates a sectional view of an electrode tab and a tab mounting portion according to another embodiment. FIG. 5 illustrates a sectional view of an electrode tab and a tab mounting portion according to still another embodiment.

Referring to FIGS. 4 and 5, each of the first and second electrode tabs 220a or 220b may be mounted on the tab mounting portion 250a or 250b provided to a protective circuit module 260a and 260b. In this case, a second alignment portion 251a or 251b provided to the tab mounting portion 250a or 250b may further include an end portion 252a or 252b inserted into an opening as a first alignment portion provided to each of the first and second electrode tabs 220a or 220b and then contacted with an outer surface of each of the first and second electrode tabs 220a or 220b.

In FIG. 4, the second alignment portion 251a may be inserted into the first alignment portion in an X-direction and then fixed by the end portion 252a contacted with the outer surface of each of the first and second electrode tabs 220a. In this case, the end portion 252a may be formed in the shape of a hook that protrudes in a Y-direction. In FIG. 5, the second alignment portion 251b may be inserted into the first alignment portion and then fixed by a mushroom-shaped end portion 252b. The section of the hook- or mushroom-shaped end portion 252a and 252b may be formed to be greater than a section of the opening as the first alignment portion, and accordingly, the second alignment portion 251a or 251b inserted into the opening as the first alignment portion may be firmly fixed. The outer surface of the first alignment portion may further include surface roughness. For example, the surface roughness may be provided at a portion that contacts the end portion 252a or 252b of the second alignment portion 251a or 251b on the outer surface of the first alignment portion. Accordingly, each of the first and second electrode tabs 220a or 220b may be firmly fixed to the tab mounting portion 250a or 250b.

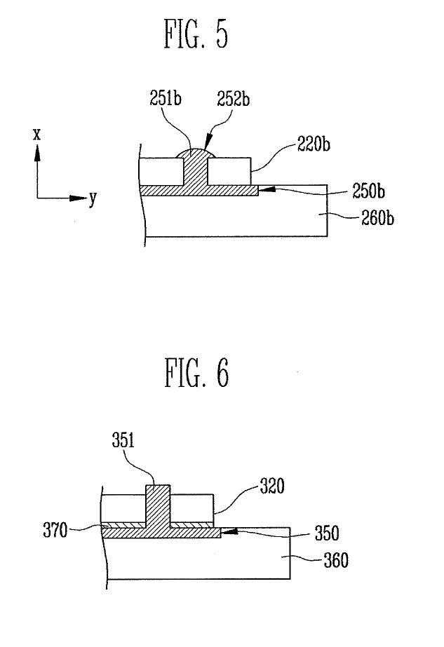

FIG. 6 illustrates a sectional view of an electrode tab and a tab mounting portion according to still another embodiment.

Referring to FIG. 6, each of the first and second electrode tabs 230 may be mounted on the tab mounting portion 350 of a protective circuit module 360. A coupling layer 370 may be further included between the tab mounting portion 350 and each of the first and second electrode tabs 320. An opening as a first alignment portion may be provided to each of the first and second electrode tabs 320, and a second alignment portion 351 inserted into the first alignment portion may be provided to the tab mounting portion 350. Each of the first and second electrode tabs 320 may include the coupling layer 370. The coupling layer 370 may be provided at only an edge portion of the opening that is the first alignment portion. The coupling layer 370 may be made of an adhesive material that allows each of the first and second electrode tabs 320 and the tab mounting portion 350 to be electrically connected to each other and simultaneously allows each of the first and second electrode tabs 320 and the tab mounting portion 350 to be physically fixed to each other. For example, the coupling layer 370 may include an Ag paste or a conductive adhesive.

When each of the first and second electrode tabs 320 is provided on the tab mounting portion 350, a size of the tab mounting portion 350 may be identical to or greater than each of the first and second electrode tabs 320, in consideration of a process margin. If a coupling layer were to be provided to the tab mounting portion 350, an unnecessary portion of the coupling layer may remain around each of the first and second electrode tabs 320 after each of the first and second electrode tabs 320 is mounted on the tab mounting portion 350. Therefore, an external appearance failure may result. According to embodiments, on the other hand, the coupling layer 370 is provided to each of the first and second electrode tabs 320, which identical in size to, or smaller than, the tab mounting portion 350, such that it may be possible to prevent an external appearance failure due to an excess amount of a coupling layer on the tab mounting portion 350 and to prevent a waste of material in forming an unnecessary portion of the coupling layer, thereby reducing material cost.

By way of summation and review, as electronic devices have become smaller in size and lighter in weight, battery packs with a small size and light weight have become desirable. However, a material such as lithium having high reactivity may be provided to the inside of the battery pack. Accordingly, an extent to which size and weight of the battery pack may be decreased is limited due to the safety concern. Accordingly, it is desirable to develop a battery pack that is small in size and light in weight without compromising the safety of the battery pack.

Embodiments provide a battery pack having a new electrode tab. Embodiments also provide a battery pack capable of improving process efficiency by applying a new method for attaching a protective circuit module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A battery pack, including:
a secondary battery, including an electrode tab extending from the secondary battery, the electrode tab including a first alignment portion; and
a protective circuit module including a tab mounting portion, the tab mounting portion including a second alignment portion that engages the first alignment portion.

2. The battery pack as claimed in claim 1, wherein the second alignment portion engages the first alignment portion when the electrode tab is aligned in an overlapping relationship with the tab mounting portion.

3. The battery pack as claimed in claim 1, wherein:
the electrode tab extends from the secondary battery in a first direction, and
the tab mounting portion extends on a surface of the protective circuit module in the first direction.

4. The battery pack as claimed in claim 1, wherein a width of the tab mounting portion is about 1 to about 1.2 times the width of the electrode tab.

5. The battery pack as claimed in claim 1, wherein a width of the tab mounting portion is about 5 to 7 mm, and a width of the electrode tab is about 5 to 6 mm.

6. The battery pack as claimed in claim 1, wherein:
one of the first alignment portion and the second alignment portion includes a hole, and
the other one of the first alignment portion and the second alignment portion includes a projection associated therewith, which alignment portion engages the hole.

7. The battery pack as claimed in claim 6, wherein the projection has an integral, one piece construction with the alignment portion with which it is associated.

8. The battery pack as claimed in claim 1, wherein:
the first alignment portion includes a hole, and
the second alignment portion includes a projection that engages the hole.

9. The battery pack as claimed in claim 8, wherein the projection has an integral, one piece construction with the tab mounting portion.

10. The battery pack as claimed in claim 9, wherein the projection has a cross-section corresponding to a cross-section of the hole.

11. The battery pack as claimed in claim 9, wherein the projection has a height greater than a height of the electrode tab such that an end portion of the projection protrudes from the hole.

12. The battery pack as claimed in claim 11, wherein the end portion of the projection protrudes from the hole by about 0.5 to about 1 mm.

13. The battery pack as claimed in claim 11, wherein the end portion of the projection includes a hook portion that engages the electrode tab on an opposite side of the electrode tab from the tab mounting portion.

14. The battery pack as claimed in claim 11, wherein the end portion of the projection includes a convex head portion that engages the electrode tab on an opposite side of the electrode tab from the tab mounting portion.

15. The battery pack as claimed in claim 1, further including a coupling layer between the electrode tab and the tab mounting portion.

16. The battery pack as claimed in claim 15, wherein the coupling layer has adhesive properties.

17. The battery pack as claimed in claim 15, wherein the coupling layer is an Ag paste or a conductive adhesive.

18. The battery pack as claimed in claim 15, wherein the coupling layer has an area that is equal to or less than an area of the tab mounting portion.

19. The battery pack as claimed in claim 1, wherein:
the electrode tab includes first and second electrode tabs extending from the secondary battery, each of the first and second electrode tabs including the first alignment portion;
the tab mounting portion includes first and second tab mounting portions, each of the first and second tab mounting portions including the second alignment portion that engages the first alignment portion of a corresponding one of the first and second electrode tabs.

20. The battery pack as claimed in claim 1, wherein the battery is a pouch-type battery.
